(19) United States
(12) Patent Application Publication
(10) Pub. No.: US 2025/0162071 A1
(43) Pub. Date: May 22, 2025

(54) LASER PROCESSING SYSTEM AND LASER PROCESSING METHOD

(71) Applicant: Fanuc Corporation, Minamitsuru-gun, Yamanashi (JP)

(72) Inventor: Takashi IZUMI, Minamitsuru-gun, Yamanashi (JP)

(73) Assignee: Fanuc Corporation, Minamitsuru-gun, Yamanashi (JP)

(21) Appl. No.: 18/840,152

(22) PCT Filed: Mar. 7, 2022
(86) PCT No.: PCT/JP2022/009809

§ 371 Date: Aug. 21, 2024

(51) Int. Cl. B23K 26/08

(52) U.S. Cl. CPC B23K 26/0876

(57) ABSTRACT

A laser processing system includes a laser emission device, a robot that moves the laser emission device with the laser emission device removably mounted thereon, a mounting detection sensor that detects whether or not the laser emission device is mounted on the robot, a control device that controls a laser beam emission operation by a laser oscillator and a movement operation by the robot, and a mode selection switch that selects an operation mode of laser processing. The control device executes the laser beam emission operation and the movement operation in an automatic operation mode if the automatic operation mode is selected by the mode selection switch and the mounting detection sensor has detected that the laser emission device is mounted on the robot.

### CROSS REFERENCE TO RELATED APPLICATIONS

This is the U.S. National Phase application of PCT/JP2022/009809, filed Mar. 7, 2022, the disclosures of this application being incorporated herein by reference in its entirety for all purposes.

### FIELD OF THE INVENTION

The present disclosure relates to a laser process system and a laser process method.

### BACKGROUND OF THE INVENTION

A laser process system that performs a laser process on a workpiece has been known (e.g., Patent Literature 1).

### PATENT LITERATURE

PTL 1: JP 2015-167974 A

### SUMMARY OF THE INVENTION

In the laser process system, a laser process may be executed in an automatic drive mode in which a robot and a laser oscillator are automatically driven in accordance with a process program. In this case, the safety of the operator needs to be ensured.

A laser process system that performs a laser process on a workpiece according to one aspect of the present disclosure includes: a laser emitting device configured to emit a laser beam generated by a laser oscillator; a robot to which the laser emitting device is detachably attached, the robot being configured to move the laser emitting device relative to the workpiece; an attachment detection sensor configured to detect attachment of the laser emitting device to the robot; a controller configured to control a laser beam emitting operation to operate the laser oscillator so as to emit the laser beam from the laser emitting device, and a movement operation to operate the robot so as to move the laser emitting device relative to the workpiece; and a mode selection switch for selecting a drive mode of the laser process.

The controller executes the laser beam emitting operation and the movement operation as an automatic drive mode in which the laser beam emitting operation and the movement operation are automatically executed in accordance with a process program, when the automatic drive mode is selected as the drive mode by the mode selection switch, and the attachment detection sensor detects the attachment of the laser emitting device to the robot.

According to the present disclosure, the automatic drive of the laser process system can be safely executed, thus ensuring the safety of the operator for the automatic drive.

### BRIEF DESCRIPTION OF DRAWINGS

FIG. 1 is a schematic diagram of a laser process system according to an embodiment.

FIG. 2 is a block diagram of a laser process system according to an embodiment.

FIG. 3 illustrates a mode selection switch according to an embodiment.

FIG. 4 illustrates an attachment detection sensor that is a contact sensor.

FIG. 5 illustrates a state in which a laser emitting device is detached from a robot in the attachment detection sensor illustrated in FIG. 4.

FIG. 6 illustrates an attachment detection sensor that is a non-contact sensor.

FIG. 7 is a flowchart illustrating an example of a laser c executed by the laser process system illustrated in FIG. 2.

FIG. 8 is a flowchart illustrating an example of step S2 in FIG. 7.

FIG. 9 is a flowchart illustrating an example of step S3 in FIG. 7.

FIG. 10 is a block diagram of a laser process system according to another embodiment.

FIG. 11 is a flowchart illustrating an example of step S2 in FIG. 7 executed by the laser process system illustrated in FIG. 10.

FIG. 12 is a schematic diagram of a laser process system according to yet another embodiment.

FIG. 13 is a block diagram of the laser process system illustrated in FIG. 12.

FIG. 14 is a flowchart illustrating an example of step S2 in FIG. 7 executed by the laser process system illustrated in FIG. 13.

FIG. 15 illustrates an example of a mode selection switch image.

FIG. 16 is a schematic diagram of a laser process system according to yet another embodiment.

FIG. 17 is a block diagram of the laser process system illustrated in FIG. 16.

FIG. 18 is a block diagram of a laser process system according to yet another embodiment.

### DETAILED DESCRIPTION OF EMBODIMENTS OF THE INVENTION

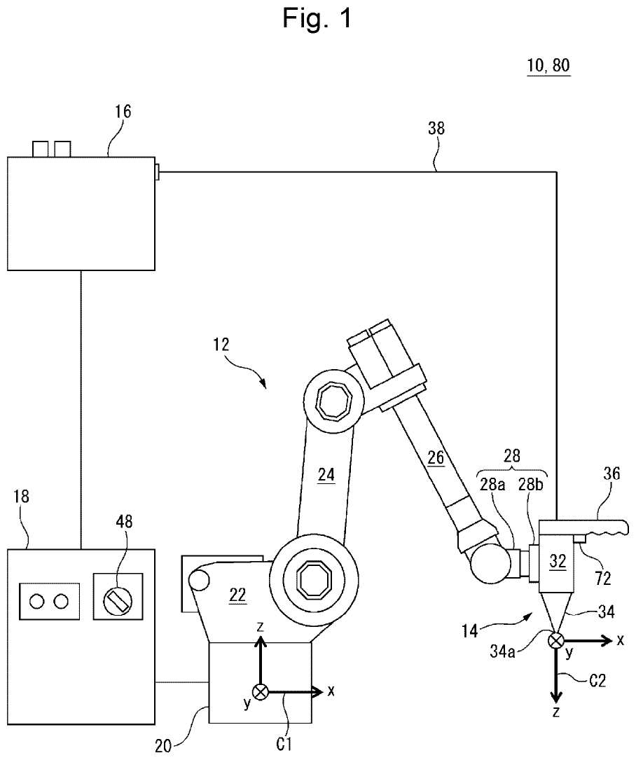

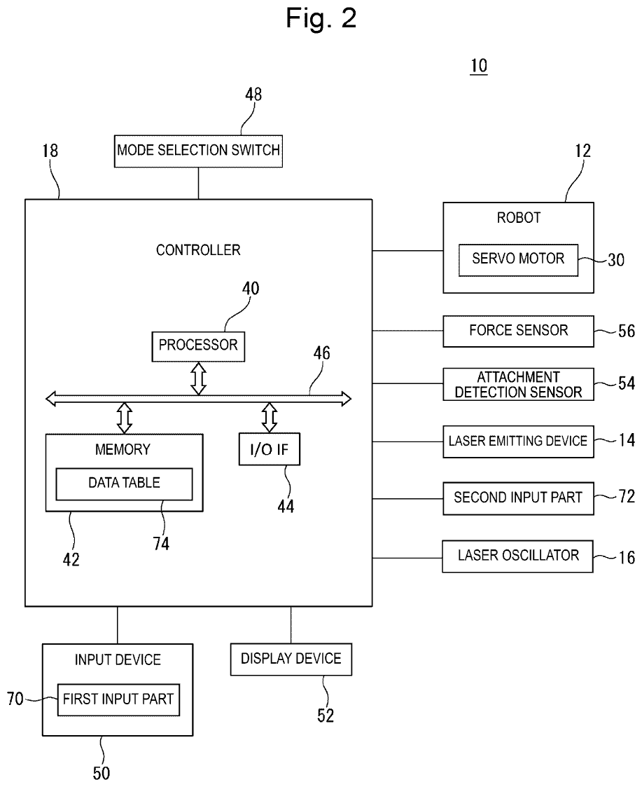

Embodiments of the present disclosure are described in detail below with reference to the drawings. Note that in various embodiments described below, the same elements are denoted with the same reference numerals, and overlapping description is omitted. First, a laser process system 10 according to an embodiment will be described with reference to FIG. 1 and FIG. 2. The laser process system 10 is a system capable of executing a laser process (such as laser welding and laser cutting) on a workpiece (not illustrated) in cooperation with an operator.

Specifically, the laser process system 10 includes a robot 12, a laser emitting device 14, a laser oscillator 16, and a controller 18. The robot 12 moves the laser emitting device 14 relative to a workpiece. In the present embodiment, the robot 12 is a vertical articulated robot and includes a robot base 20, a swivel body 22, a lower arm 24, an upper arm 26, and a wrist 28.

The robot base 20 is fixed on a floor of a work cell. The swivel body 22 is provided at the robot base 20 being turnable around the vertical axis. The lower arm 24 is provided at the swivel body 22 so as to be rotatable about a horizontal axis. The upper arm 26 is rotatably provided at the distal end portion of the lower arm 24. The wrist 28 includes a wrist base 28a provided at a distal end portion of the upper arm 26 so as to be rotatable around two axes perpendicular to each other, and a wrist flange 28b rotatably provided at the wrist base 28a.

The components of the robot 12 (the robot base 20, the swivel body 22, the lower arm 24, the upper arm 26, and the wrist 28) are respectively provided with a plurality of servomotors 30 (FIG. 2). The servomotor 30 causes each of the movable components (the swivel body 22, the lower arm 24, the upper arm 26, the wrist 28, and the wrist flange 28b) of the robot 12 to rotate about a drive axis in response to a command from the controller 18. Thus, the robot 12 moves the laser emitting device 14 relative to the workpiece.

The laser emitting device 14 is detachably attached to the wrist flange 28b of the robot 12, to emit a laser beam LB generated by the laser oscillator 16. In the present embodiment, the laser emitting device 14 is a laser process head and includes a head main body 32, a nozzle 34, and a gripping part 36. The head main body 32 is made to be hollow and accommodates therein optical system components such as an optical lens (such as a collimator lens or a focus lens) and a lens drive part (e.g., a servomotor) that displaces the optical lens in response to a command from the controller 18.

The nozzle 34 is made to be hollow, and is provided at a distal end portion of the head main body 32. The nozzle 34 has a truncated conical outline with a cross-sectional area that decreases from a base end portion toward a distal end portion thereof, and an exit port 34a is formed at the distal end portion.

A hollow chamber is formed inside the nozzle 34 and the head main body 32, and an assist gas is supplied into the chamber from an assist gas supply device (not illustrated) provided outside. The laser beam LB generated by the laser oscillator 16 propagates through the chamber and is emitted from the exit port 34a together with the assist gas.

The gripping part 36 is provided at the base end portion of the head main body 32 such that the operator can grip the gripping part 36 with one hand. The gripping part 36 may have recesses corresponding to the fingers of one hand to make it easier for the operator to grip the gripping part 36 with the one hand. The operator can carry the laser emitting device 14 by gripping the gripping part 36 and removing the laser emitting device 14 from the wrist flange 28b.

The laser oscillator 16 performs laser oscillation internally and generates the laser beam LB, in response to a command CM1 (such as a laser power command) from the controller 18. The laser oscillator 16 may be of any type, such as a fiber laser oscillator, a CO₂ laser oscillator, or a solid state laser (YAG laser) oscillator. The laser oscillator 16 supplies the generated laser beam LB to the laser emitting device 14 through a light guide path 38. The light guide path 38 includes an optical fiber, a cavity, a light guide material such as crystal, a reflecting mirror, an optical lens, or the like.

The controller 18 controls a laser beam emitting operation LO of emitting the laser beam LB from the laser emitting device 14 by operating the laser oscillator 16, and a movement operation MO of moving the laser emitting device 14 relative to the workpiece by operating the robot 12. Specifically, the controller 18 is a computer including a processor 40, a memory 42, and an I/O interface 44.

The processor 40 includes a CPU, a GPU, or the like, and is communicably connected to the memory 42 and the I/O interface 44 via a bus 46, and executes various types of arithmetic processing to execute a laser process described below while communicating with these components. The memory 42 includes a RAM, a ROM, or the like and temporarily or permanently stores various types of data used for the arithmetic processing executed by the processor 40 and various types of data generated during the arithmetic processing.

The I/O interface 44 includes, for example, an Ethernet (trade name) port, a USB port, an optical fiber connector, or an HDMI (trade name) terminal, and performs wired or wireless data communication with an external apparatus under a command from the processor 40. The robot 12 (servomotors 30), the laser emitting device 14 (lens drive part), and the laser oscillator 16 are communicably connected to the I/O interface 44.

As illustrated in FIG. 1, the robot 12 is provided with a robot coordinate system C1. The robot coordinate system C1 is a coordinate system for automatically controlling the operation of each movable component of the robot 12. In the present embodiment, the robot coordinate system C1 is set in a fixed manner relative to the robot base 20 such that the origin of the robot coordinate system C1 is arranged at the center of the robot base 20 and the z-axis of the robot coordinate system C1 is parallel to the turning axis (that is, the vertical direction) of the swivel body 22.

On the other hand, the laser emitting device 14 is provided with a tool coordinate system C2. The tool coordinate system C2 is a coordinate system for automatically controlling the position of the laser emitting device 14 in the robot coordinate system C1, and defines the position of the laser emitting device 14 in the robot coordinate system C1. Note that, in the present description, “position” may refer to a position and an orientation.

In the present embodiment, the tool coordinate system C2 is set with respect to the laser emitting device 14 so that the origin (i.e., TCP) of the tool coordinate system C2 is arranged at the center of the exit port 34a of the laser emitting device 14, and the z-axis of the tool coordinate system C2 is parallel to (specifically, coincides with) the optical axis of the emitted laser beam LB. The position of the laser emitting device 14 is represented by coordinates Q (X, Y, Z, W, P, R) of the tool coordinate system C2 in the robot coordinate system C1.

Of the coordinates Q, the coordinates (X, Y, Z) indicate the position of the laser emitting device 14 in the robot coordinate system C1 (that is, the origin of the tool coordinate system C2), and the coordinates (W, P, R) indicate an orientation OR of the laser emitting device 14 in the robot coordinate system C1 (that is, the direction of each axis of the tool coordinate system C2) (i.e., yaw, pitch, and roll).

When moving the laser emitting device 14, the controller 18 sets the tool coordinate system C2 in the robot coordinate system C1, and generates a command CM2 (such as position command, speed command, and torque command) to each servomotor 30 of the robot 12 such that the laser emitting device 14 is arranged at a position represented by the set tool coordinate system C2. Thus, the controller 18 can operate the robot 12 and arranged the laser emitting device 14 at any position in the robot coordinate system C1.

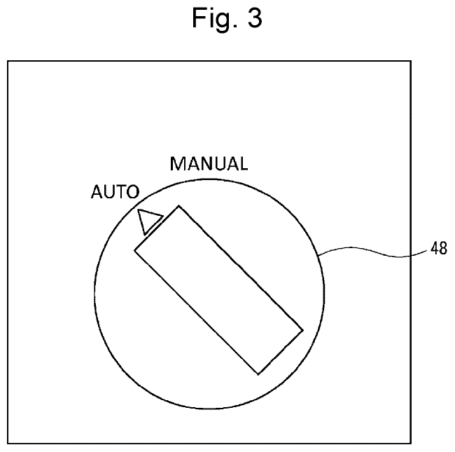

In the present embodiment, the controller 18 is provided with a mode selection switch 48. The mode selection switch 48 is used to select a drive mode DM for the laser process executed by the controller 18. As illustrated in FIG. 3, in the present embodiment, the mode selection switch 48 is configured to switch the drive mode DM between an automatic drive mode DM1 represented as “AUTO” and a manual drive mode DM2 represented as “MANUAL”.

The automatic drive mode DM1 is the drive mode DM in which the controller 18 automatically executes the laser beam emitting operation LO and the movement operation MO in accordance with a process program PG generated in advance. In the automatic drive mode DM1, the controller 18 sequentially generates the command CM1 for the laser oscillator 16 and the command CM2 for the robot 12 (servomotor 30) in accordance with the process program PG, and automatically drives the laser oscillator 16 and the robot 12 in accordance with the commands CM1 and CM2. The process program PG may include a first process program PG1 that defines the operation of the laser oscillator 16 and a second process program PG2 that defines the operation of the robot 12. The process program PG (PG1 and PG2) is stored in the memory 42 in advance.

On the other hand, the manual drive mode DM2 is the drive mode DM in which the operator manually grips and carries the laser emitting device 14, causes the controller 18 to manually execute the laser beam emitting operation LO, and manually perform a laser process on the workpiece using the laser beam LB emitted from the laser emitting device 14. In the manual drive mode DM2, the operator manually issues a manual emission command CM3 to be described below to the controller 18, and the controller 18 executes the laser beam emitting operation LO in response to the manual emission command CM3.

The operator can switch the drive mode DM between the automatic drive mode DM1 and the manual drive mode DM2 by operating the mode selection switch 48. FIG. 3 illustrates a state in which the automatic drive mode DM1 (“AUTO”) is selected using the mode selection switch 48.

When the automatic drive mode DM1 is selected using the mode selection switch 48, the mode selection switch 48 supplies an automatic drive mode transition command CM4 to the controller 18.

On the other hand, when the manual drive mode DM2 is selected using the mode selection switch 48, the mode selection switch 48 supplies a manual drive mode transition command CM5 to the controller 18. Note that the automatic drive mode transition command CM4 and the manual drive mode transition command CM5 may be ON/OFF signals (e.g., the automatic drive mode transition command CM4 may be an ON signal, and the manual drive mode transition command CM5 may be an OFF signal).

As illustrated in FIG. 2, the controller 18 is further provided with an input device 50 and a display device 52. The input device 50 includes a keyboard, a mouse, a touch panel, or the like and receives data input from the operator. The display device 52 includes a liquid crystal display, an organic EL display, or the like and displays various types of data.

The input device 50 and the display device 52 are communicably connected to the I/O interface 44 by wire or wirelessly. The input device 50 and the display device 52 may be integrally incorporated in a housing of the controller 18, or may be provided as one computer (such as a PC) that is a component separate from the housing of the controller 18, for example.

The laser process system 10 further includes an attachment detection sensor 54 and a force sensor 56. The attachment detection sensor 54 detects attachment of the laser emitting device 14 to the robot 12. As an example, the attachment detection sensor 54 includes a contact sensor that detects attachment of the laser emitting device 14 to the wrist flange 28b by becoming conductive when the laser emitting device 14 is attached to the wrist flange 28b and becoming non-conductive when the laser emitting device 14 is detached from the wrist flange 28b.

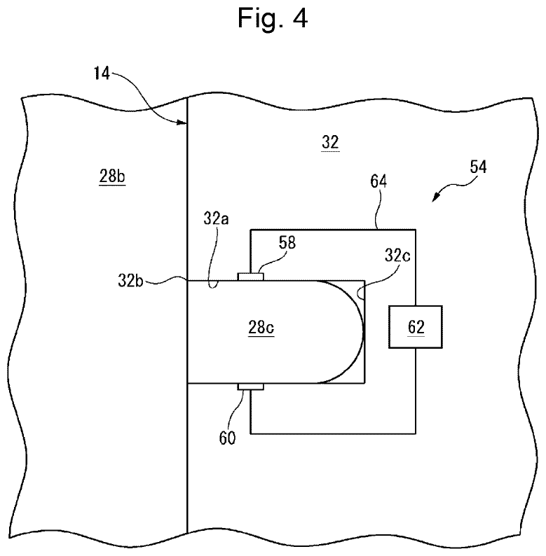

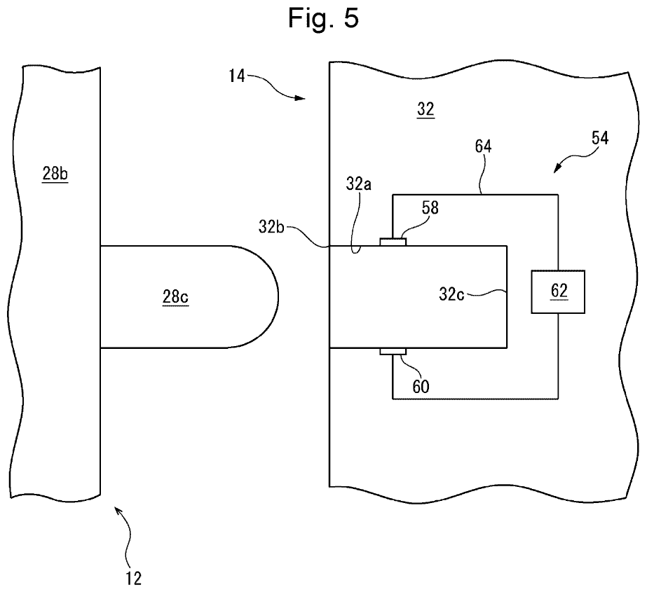

FIG. 4 and FIG. 5 illustrate an example of the attachment detection sensor 54 that is a contact sensor as described above. In the example illustrated in FIG. 4 and FIG. 5, the attachment detection sensor 54 is incorporated in the outer wall of the head main body 32, and includes a pair of terminals 58 and 60, a resistance detection sensor 62, and a conductive wire 64 that establishes electrical connection between the terminals 58 and 60 and the resistance detection sensor 62.

The terminals 58 and 60 are made of a conductive material (such as iron and copper) and are disposed to face each other so as to be exposed to a space defined inside a hole 32a formed in the outer wall of the head main body 32. The resistance detection sensor 62 is connected to the I/O interface 44 of the controller 18 and detects a resistance R between the terminals 58 and 60 by applying a voltage between the terminals 58 and 60.

On the other hand, the wrist flange 28b is provided with a protruding portion 28c protruding outward from the outer surface of the wrist flange 28b. The protruding portion 28c is made of a conductive material (such as iron and copper). When the laser emitting device 14 is properly attached to the wrist flange 28b as illustrated in FIG. 4, the protruding portion 28c is inserted in the hole 32a and contacts the terminals 58 and 60. As a result, the terminals 58 and 60 are electrically connected to each other via the protruding portion 28c.

On the other hand, as illustrated in FIG. 5, when the laser emitting device 14 is detached from the wrist flange 28b, the terminals 58 and 60 become non-conductive, and the resistance R between the terminals 58 and 60 significantly increases (R≈∞). The resistance detection sensor 62 detects the resistance R that changes in response to the attachment of the laser emitting device 14 to the wrist flange 28b, and detects the attachment of the laser emitting device 14 to the wrist flange 28b based on the resistance R.

For example, when the detected resistance R exceeds a predetermined threshold Rₜₕ (R>Rₜₕ), the resistance detection sensor 62 transmits, to the controller 18, a detachment signal Sd (e.g., an OFF or “0” signal) indicating the detachment of the laser emitting device 14 from the wrist flange 28b. Alternatively, the resistance detection sensor 62 may transmit detection data Dr of the resistance R to the controller 18, and the processor 40 of the controller 18 may determine whether or not R>Rₜₕ holds, to detect the detachment of the laser emitting device 14.

Thus, the contact-type attachment detection sensor 54 illustrated in FIG. 4 and FIG. 5 detects attachment of the laser emitting device 14 to the wrist flange 28b by coming into contact with the protruding portion 28c that is a member of the robot 12. With such a contact sensor, detachment of the laser emitting device 14 from the wrist flange 28b can be more reliably detected.

Note that the pair of terminals 58 and 60 may be provided at positions closer to a bottom portion 32c than to an opening portion 32b of the hole 32a. With this configuration, the attachment detection sensor 54 can detect even a slight detachment (displacement) of the laser emitting device 14 from the wrist flange 28b. The attachment detection sensor 54 may be incorporated in the wrist flange 28b. In this case, the hole 32a is formed at the wrist flange 28b, whereas the protruding portion 28c is formed on the outer wall of the head main body 32.

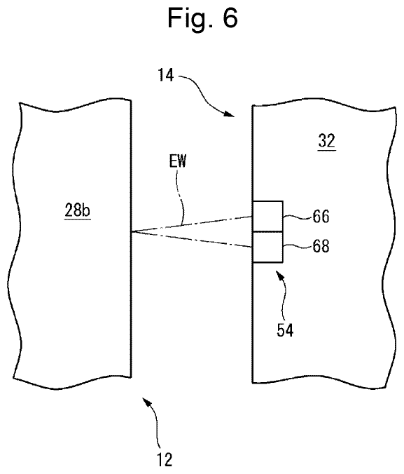

As another example, the attachment detection sensor 54 may include a non-contact sensor that detects attachment of the laser emitting device 14 to the wrist flange 28b in a non-contact manner. FIG. 6 illustrates an example of the attachment detection sensor 54 as such a non-contact sensor. In the example illustrated in FIG. 6, the attachment detection sensor 54 is incorporated in the outer wall of the head main body 32, and includes a transmitter 66 and a receiver 68. The transmitter 66 transmits electromagnetic waves EW (e.g., infrared rays) toward the wrist flange 28b.

When the laser emitting device 14 is properly attached to the wrist flange 28b, the electromagnetic waves EW transmitted from the transmitter 66 are reflected at the outer surface of the wrist flange 28b. The receiver 68 receives the electromagnetic waves EW reflected at the wrist flange 28b. The attachment detection sensor 54 illustrated in FIG. 6 detects attachment of the laser emitting device 14 to the wrist flange 28b in a non-contact manner in response to the electromagnetic waves EW received by the receiver 68.

For example, when the reflected electromagnetic waves EW are not detected, the receiver 68 transmits, to the controller 18, the detachment signal Sd indicating the detachment of the laser emitting device 14 from the wrist flange 28b. Alternatively, the receiver 68 may transmit detection data De of the electromagnetic waves EW to the controller 18, and the processor 40 of the controller 18 may detect the detachment of the laser emitting device 14 based on the detection data De.

According to such a non-contact sensor, detachment of the laser emitting device 14 from the wrist flange 28b can be quickly detected in a non-contact manner. The transmitter 66 of the attachment detection sensor 54 may be provided at one of the wrist flange 28b and the head main body 32, and the receiver 68 may be provided at the other one of the wrist flange 28b and the head main body 32.

Referring back to FIG. 1 and FIG. 2, the force sensor 56 detects external force F applied to the robot 12 or the laser emitting device 14. As an example, the force sensor 56 includes a torque sensor that is incorporated in each servomotor 30 of the robot 12 and detects torque applied to an output shaft of the servomotor 30.

The processor 40 of the controller 18 can detect the magnitude and the direction of the external force F applied to the robot 12 (e.g., the upper arm 26 or the wrist 28) or the laser emitting device 14, and the part (e.g., the upper arm 26, the wrist 28, or the laser emitting device 14) to which the external force F is applied, from detection data Dt of each torque sensor.

As another example, the force sensor 56 includes a six-axis force sensor. The six-axis force sensor is incorporated in a component (e.g., the robot base 20 or the wrist 28) of the robot 12, and includes a cylindrical main body portion and a plurality of strain gauges provided at the main body portion. The controller 18 can detect the magnitude and the direction of the external force F applied to the robot 12 or the laser emitting device 14 and the part to which the external force F is applied, from detection data Df of each strain gauge.

As yet another example, the force sensor 56 includes a current sensor that detects a feedback current from each servomotor 30. Since the feedback current changes in response to the torque applied to the servomotor 30, the controller 18 can detect the external force F from detection data Di (that is, the feedback current) of each current sensor, as with the above-described torque sensor.

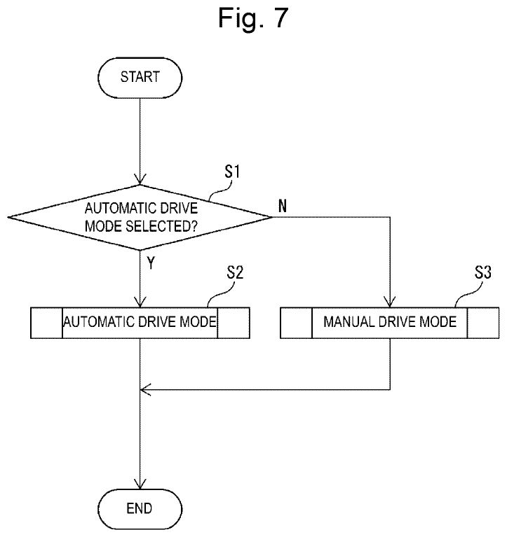

The laser process method executed by the laser process system 10 will be described with reference to FIG. 7 to FIG. 9. A flow in FIG. 7 starts when the processor 40 of the controller 18 receives an operation start command (e.g., a power ON command) from the operator, a computer program, or a host controller, for example.

In step S1, the processor 40 determines whether or not the automatic drive mode DM1 is selected by the mode selection switch 48. Specifically, the processor 40 determines whether or not the automatic drive mode transition command CM4 is received or the manual drive mode transition command CM5 is received from the mode selection switch 48. The processor 40 determines YES and proceeds to step S2 when the automatic drive mode transition command CM4 is received, and determines NO and proceeds to step S3 when the manual drive mode transition command CM5 is received.

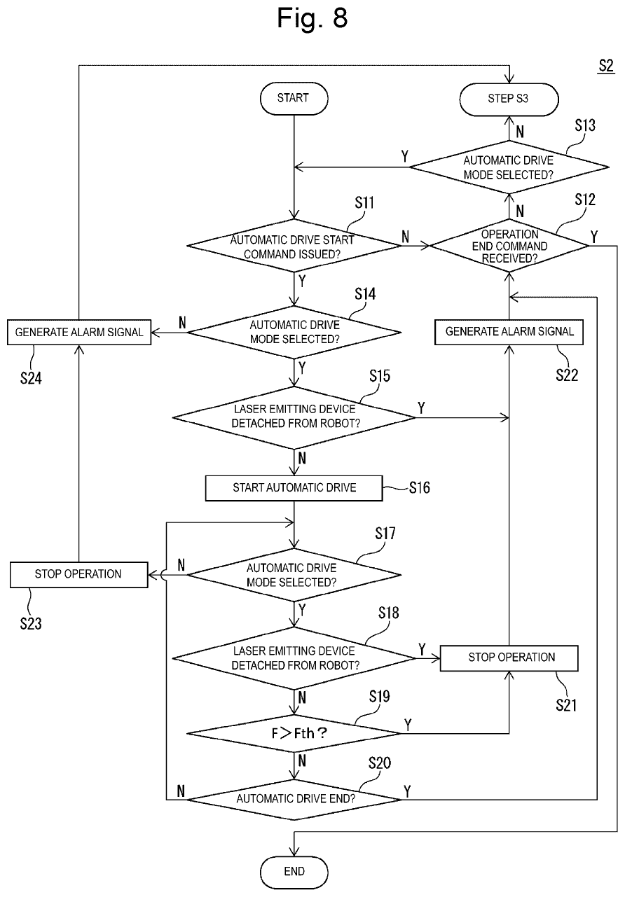

In step S2, the processor 40 causes the transition of the drive mode DM to the automatic drive mode DM1. An operation flow in the automatic drive mode DM1 in step S2 will be described below with reference to FIG. 8. After the transition to the automatic drive mode DM1, in step S11, the processor 40 determines whether or not an automatic drive start command CM6 for causing the controller 18 to start the automatic drive in the automatic drive mode DM1 is received.

Specifically, the processor 40 generates an automatic drive start image (not illustrated) displaying a button image for starting the automatic drive, and displays the automatic drive start image at the display device 52. By operating the input device 50 to click the button image displayed in the automatic drive start image, the operator can perform an input to issue the automatic drive start command CM6 to the controller 18.

Thus, in the present embodiment, the input device 50 functions as a first input part 70 (FIG. 1) that receives an input of the automatic drive start command CM6 that causes the controller 18 to start the automatic drive mode DM1. The processor 40 determines YES and proceeds to step S14 upon receiving the automatic drive start command CM6, and proceeds to step S12 upon determining NO.

In step S12, the processor 40 determines whether or not an operation end command CM7 (e.g., a shutdown command) is received. For example, the operator operates the input device 50 to input the operation end command CM7. Upon receiving the operation end command CM7, the processor 40 determines YES and ends the flow in step S2 illustrated in FIG. 8, and thus ends the flow illustrated in FIG. 7. On the other hand, upon determining NO, the processor 40 proceeds to step S13.

In step S13, the processor 40 determines whether or not the automatic drive mode DM1 is still selected by the mode selection switch 48. The processor 40 returns to step S11 upon determining YES, and proceeds to step S3 in FIG. 7 upon determining NO (when the mode selection switch 48 is switched to the manual drive mode DM2).

In step S14, the processor 40 determines whether or not the automatic drive mode DM1 is still selected by the mode selection switch 48, as in step S13. The processor 40 proceeds to step S15 upon determining YES, and proceeds to step S24 upon determining NO.

In step S15, the processor 40 determines whether or not the laser emitting device 14 is detached from the robot 12 (specifically, the wrist flange 28b). Specifically, the processor 40 determines whether or not the detachment of the laser emitting device 14 from the robot 12 is detected by the attachment detection sensor 54 based on the detachment signal Sd or the detection data Dr or De described above. When the detachment of the laser emitting device 14 from the robot 12 is detected, the processor 40 determines YES and proceeds to step S22. On the other hand, when the attachment of the laser emitting device 14 to the robot 12 is detected, the processor 40 determines NO and proceeds to step S16.

In step S16, the processor 40 starts the automatic drive. Specifically, the processor 40 sequentially generates the command CM1 to the laser oscillator 16 and the command CM2 to the robot 12 in accordance with the process program PG, and starts the automatic drive of executing the laser beam emitting operation LO and the movement operation MO automatically.

In step S17, the processor 40 determines whether or not the automatic drive mode DM1 is still selected by the mode selection switch 48, as in step S14 described above. The processor 40 proceeds to step S18 upon determining YES, and proceeds to step S23 upon determining NO.

In step S18, as in step S15 described above, the processor 40 determines whether or not the laser emitting device 14 is detached from the robot 12. The processor 40 proceeds to step S21 upon determining YES, and proceeds to step S19 upon determining NO.

In step S19, the processor 40 determines whether or not the external force F detected by the force sensor 56 exceeds a predetermined threshold Fₜₕ (F>Fₜₕ). The processor 40 proceeds to step S21 upon determining that F>Fₜₕ holds and thus determining YES, and proceeds to step S20 upon determining NO.

The processor 40 may monitor external force F1 applied to a specific part of the robot 12 and the laser emitting device 14 (e.g., the wrist 28 or the laser emitting device 14) based on the detection data Dτ, Df, or Di of the force sensor 56, and determine YES when the external force F1 exceeds a threshold F1ₜₕ (F1>F1ₜₕ).

In step S20, the processor 40 determines whether or not the automatic drive has ended. For example, the processor 40 can determine, from the process program PG executed, whether or not the laser beam emitting operation LO and the movement operation MO defined in the process program PG have been entirely completed. The processor 40 proceeds to step S12 upon determining YES, and returns to step S17 upon determining NO. Thus, the processor 40 repeatedly executes the loop of steps S17 to S20 until determining YES in step S18, S19, or S20, and executes the laser beam emitting operation LO and the movement operation MO as the automatic drive mode DM1.

On the other hand, upon determining YES in step S18 or S19, the processor 40 stops at least one of the laser beam emitting operation LO and the movement operation MO in step S21. As an example, the processor 40 may stop both the laser beam emitting operation LO and the movement operation MO in step S21.

Specifically, the processor 40 stops the operation of the servomotor 30 by stopping a command (torque command or the like) to each servomotor 30 of the robot 12, thereby stopping the movement operation MO. Alternatively, in a case where a brake mechanism that brakes the output shaft of each servomotor 30 is provided, the processor 40 may operate each brake mechanism to forcibly stop the operation of each servomotor 30, to stop the movement operation MO.

The processor 40 stops the laser beam emitting operation LO by stopping the laser beam generation operation by the laser oscillator 16. Alternatively, when the laser oscillator 16 is provided with a shutter that automatically opens/closes an optical path of the laser beam LB, the processor 40 may stop the laser beam emitting operation LO by blocking the laser beam LB by the shutter.

As another example, the processor 40 may continue the movement operation MO while stopping the laser beam emitting operation LO in step S21 upon determining YES in step S18, and may stop both the laser beam emitting operation LO and the movement operation MO in step S21 upon determining YES in step S19.

As described above, in the present embodiment, the robot 12 is a cooperative robot capable of stopping the operation in response to the external force F detected by the force sensor 56. In the case of the cooperative robot that can be stopped as described above, even if the determination is YES in step S18, the safety of the operator can be ensured by stopping only the laser beam emitting operation LO.

As yet another example, the processor 40 may stop the laser beam emitting operation LO and continue the movement operation MO in step S21 after determining YES in step S18, and may stop the movement operation MO and continue the laser beam emitting operation LO in step S21 after determining YES in step S19. Even if the determination is YES in step S19, the safety of the operator may be ensured, as long as the orientation OR of the laser emitting device 14 (that is, the emission direction of the laser beam LB) does not largely change.

In step S22, the processor 40 generates an alarm signal AL. For example, in step S22 after determining YES in step S15 or S18, the processor 40 generates an alarm signal AL1 in a form of an image or voice providing the message “Laser emitting device may be detached from robot. Please confirm that laser emitting device is properly attached”.

On the other hand, in step S22 after determining YES in step S19, for example, the processor 40 generates an alarm signal AL2 in a form of an image or voice providing the message “Robot may have interfered with environmental object. Please check surroundings of robot”. By the processor 40, the alarm signal AL1 or AL2 generated may be displayed as an image at the display device 52 or output as a voice from a speaker (not illustrated) provided at the controller 18. After step S22, the processor 40 returns to step S12.

On the other hand, upon determining NO in step S17, the processor 40 stops at least one of the laser beam emitting operation LO and the movement operation MO in step S23, as in step S21 described above. For example, in step S23, the processor 40 stops both the laser beam emitting operation LO and the movement operation MO.

In step S24, the processor 40 generates the alarm signal AL. For example, the processor 40 generates an alarm signal AL3 in the form of an image or a voice indicating that “Automatic drive cannot be executed because drive mode is changed”. The alarm signal AL3 generated may be displayed as an image at the display device 52 or may be output as a voice from the speaker, by the processor 40. After step S24, the processor 40 proceeds to step S3 in FIG. 7.

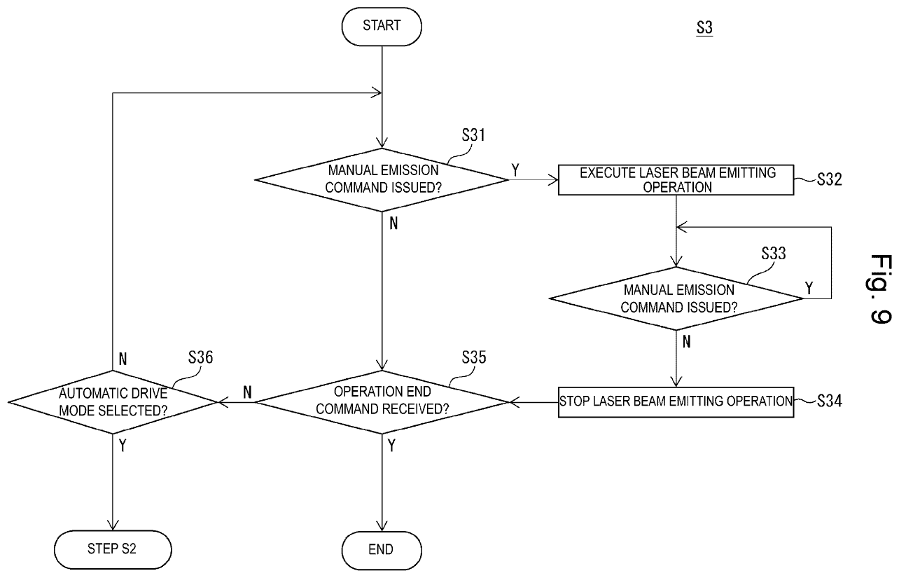

Referring back to FIG. 7, upon determining NO in step S1 (that is, when the manual drive mode DM2 is selected by the mode selection switch 48), the processor 40 makes the drive mode DM transition to the manual drive mode DM2 in step S3. An operation flow in the manual drive mode DM2 in step S3 will be described below with reference to FIG. 9.

After the transition to the manual drive mode DM2, the processor 40 determines whether or not the manual emission command CM3 is received in step S31. Here, the laser process system 10 further includes a second input part 72 (FIG. 1 and FIG. 2) that receives an input of the manual emission command CM3. The second input part 72 includes a push button, a switch, a touch panel, or the like, and is communicably connected to the I/O interface 44 of the controller 18.

In the present embodiment, the second input part 72 is provided at the laser emitting device 14 adjacent to the gripping part 36 such that an input-operation can be performed with one hand of the operator gripping the gripping part 36 of the laser emitting device 14. The operator can perform an input for manually transmitting the manual emission command CM3 to the controller 18 by operating the second input part 72 with a finger of one hand gripping the gripping part 36.

In response to the input-operation by the operator, the second input part 72 transmits the manual emission command CM3 (e.g., an ON or “1” signal) to the controller 18. In step S31, when the manual emission command CM3 is received from the second input part 72, the processor 40 determines YES, and proceeds to step S32. On the other hand, when the processor 40 proceeds to step S35 upon determining NO.

In step S32, the processor 40 executes the laser beam emitting operation LO as the manual drive mode DM2 in response to the manual emission command CM3 received through the second input part 72. In the present embodiment, the memory 42 stores in advance a data table 74 (FIG. 2) in which a process condition C_{P} for the laser process on the workpiece in the manual drive mode DM2 and an output condition C_{O} for the laser beam LB to be emitted in the laser beam emitting operation LO in the manual drive mode DM2 are stored in association with each other.

The process condition C_{P} includes, for example, a material (such as SUS and aluminum), a thickness [mm], and a melting point [° C.] of the workpiece. On the other hand, the output condition C_{O} includes, for example, a laser power [KW], a duty ratio [%], and a pulse oscillation frequency [Hz] of the laser beam LB. The data table 74 stores the output condition C_{O} (laser power, duty ratio, and pulse oscillation frequency) in association with each of the plurality of process conditions C_{P} (material, thickness, and melting point).

The processor 40 sets the output condition C_{O} in the manual drive mode DM2 in advance based on the data table 74. As an example, the operator may manually select the output condition C_{O} corresponding to the process condition C_{P} (e.g., material and thickness) of the workpiece to be processed, in the data table 74. In this case, the processor 40 generates an image of the data table 74 and displays the image at the display device 52.

While visually recognizing the image of the data table 74, the operator operates the input device 50 to search for and select the output condition C_{O} corresponding to the process condition C_{P} for the workpiece to be processed, in the data table 74. The processor 40 receives the operator's input through the input device 50 and sets the output condition C_{O} selected in the data table 74 as the output condition in the manual drive mode DM2.

As another example, the operator may operate the input device 50 to input the process condition C_{P} for the workpiece to be processed. In this case, the processor 40 automatically searches the data table 74 for the output condition C_{O} corresponding to the process condition C_{P} input by the operator through the input device 50, and sets the output condition C_{O} thus found as the output condition in the manual drive mode DM2. Thus, the processor 40 sets the output condition C_{O} in the manual drive mode DM2 in advance based on the data table 74.

In step S32, in response to the manual emission command CM3, the processor 40 generates the command CM1 for the laser oscillator 16 in accordance with the preset output condition C_{O}, and executes the laser beam emission operation LO so as to generate the laser beam LB with the laser power, the duty ratio, and the pulse oscillation frequency defined in the output condition C_{O}. As a result, the operator can manually perform the laser process on the workpiece by emitting the laser beam LB under the desired output condition C_{O} from the laser emitting device 14 gripped by one hand.

In step S33, the processor 40 determines whether or not the manual emission command CM3 is continuously received from the second input part 72 (e.g., the signal of the manual emission command CM3 continues to be ON or “1”). The processor 40 loops step S33 while determining YES, and proceeds to step S34 upon determining NO (i.e., when the signal of the manual emission command CM3 is OFF or “0”). In this way, the processor 40 continues the laser beam emission operation LO in the manual drive mode DM2 until determining NO in step S33.

In step S34, the processor 40 stops the laser beam emission operation LO. For example, the processor 40 may stop the laser beam emitting operation LO by stopping the laser beam generation operation by the laser oscillator 16 or by blocking the laser beam LB using the shutter described above.

In step S35, the processor 40 determines whether or not the operation end command CM7 is received as in step S12 described above. Upon determining YES, the processor 40 ends the flow in step S3 illustrated in FIG. 9, and thus ends the flow in FIG. 7. On the other hand, upon determining NO, the processor 40 proceeds to step S36.

In step S36, the processor 40 determines whether or not the automatic drive mode DM1 is selected by the mode selection switch 48, as in step S13 described above. The processor 40 proceeds to step S2 in FIG. 8 upon determining YES, and returns to step S31 upon determining NO.

As described above, in the present embodiment, when the automatic drive mode DM1 is selected by the mode selection switch 48 (determined YES in steps S14 and S17) and the attachment detection sensor 54 detects attachment of the laser emitting device 14 to the robot 12 (determined NO in steps S15 and S18), the controller 18 (specifically, the processor 40) executes the laser beam emitting operation LO and the movement operation MO as the automatic drive mode DM1.

Thus, in the present embodiment, the controller 18 executes the automatic drive including the laser beam emitting operation LO and the movement operation MO in the automatic drive mode DM1, only when the two conditions that are the selection of the automatic drive mode DM1 by the mode selection switch 48 and the attachment of the laser emitting device 14 to the robot 12 are satisfied. With this configuration, since the automatic drive of the laser process system 10 can be safely executed, the safety of the operator for the automatic drive can be ensured.

In the present embodiment, when the automatic drive start command CM6 is input to the first input part 70 (specifically, the input device 50), in a state where the automatic drive mode DM1 is not selected by the mode selection switch 48 (determined NO in step S14) or the detachment of the laser emitting device 14 from the robot 12 is detected by the attachment detection sensor 54 (determined YES in step S15), the controller 18 does not start the laser beam emitting operation LO and the movement operation MO as the automatic drive mode DM1. With this configuration, the safety of the operator can be reliably ensured when the automatic drive starts.

Also when the automatic drive start command CM6 is input, in a state where the automatic drive mode DM1 is not selected by the mode selection switch 48 or the attachment detection sensor 54 detects the detachment of the laser emitting device 14 from the robot 12, the processor 40 may start the laser beam emitting operation LO or the movement operation MO as the automatic drive mode DM1.

Specifically, when the robot 12 is a cooperative robot that can be stopped, the safety of the operator can be ensured even when the movement operation MO starts as the automatic drive mode DM1 in a state where the automatic drive mode DM1 is not selected by the mode selection switch 48 or the attachment detection sensor 54 detects the detachment of the laser emitting device 14 from the robot 12. If the operator is outside a safety barrier described below, the safety of the operator may be ensured even when the laser beam emitting operation LO starts as the automatic drive mode DM1.

In the present embodiment, in a state where the automatic drive mode DM1 is not selected by the mode selection switch 48 or the attachment detection sensor 54 detects the detachment of the laser emitting device 14 when the automatic drive start command CM6 is input to the first input part 70, the controller 18 generates the alarm signal AL (steps S22 and S24). With this configuration, the operator can intuitively and reliably recognize that the automatic drive mode DM1 is not selected or that the laser emitting device 14 is detached.

In the present embodiment, when the mode selection switch 48 is operated to deselect the automatic drive mode DM1 (NO in step S17) or the attachment detection sensor 54 detects detachment of the laser emitting device 14 (determined YES in step S18) while executing the laser beam emitting operation LO and the movement operation MO as the automatic drive mode DM, the controller 18 stops at least one of the laser beam emitting operation LO and the movement operation MO (step S21). With this configuration, the safety of the operator during the automatic drive can be reliably ensured.

In the present embodiment, when the external force F detected by the force sensor 56 exceeds the predetermined threshold Fₜₕ while executing the laser beam emitting operation LO and the movement operation MO in the automatic drive mode DM1 (determined YES in Step S19), the controller 18 stops at least one of the laser beam emitting operation LO and the movement operation MO (step S21). With this configuration, even when the orientation OR of the laser emitting device 14 changes due to interference of the robot 12 with a surrounding environmental object during automatic drive, and collision of the robot 12 or the laser emitting device 14 with the operator or the like occurs, the safety of the operator can be reliably ensured.

In the present embodiment, the controller 18 executes the laser beam emitting operation LO as the manual drive mode DM2 in response to the manual emission command CM3 received through the second input part 72 when the manual drive mode DM2 is selected by the mode selection switch 48 (step S32). With this configuration, the operator can manually execute a part of the laser process (e.g., laser welding) as necessary. Thus, the operator and the robot 12 can cooperate with each other to perform the laser process, whereby work efficiency can be improved.

In the present embodiment, the controller 18 sets the output condition C_{O} in the manual drive mode DM2 based on the data table 74. With this configuration, the operator can optimize the output condition C_{O} in the manual drive mode DM2 in response to the process condition C_{P} of the workpiece (such as material, thickness, and melting point of the workpiece). Alternatively, the output condition C_{O} in the manual drive mode DM2 may be predetermined by the operator as a predetermined required value without using the data table 74. In this case, the data table 74 can be omitted from the laser process system 10.

In the present embodiment, the laser emitting device 14 includes the gripping part 36 that can be gripped by the operator with one hand, and the second input part 72 is provided at the laser emitting device 14 to be adjacent to the gripping part 36 so that the one hand gripping the gripping part 36 is able to perform an input-operation. With this configuration, since the operator can grip the laser emitting device 14 and execute the input-operation on the second input part 72 with one hand, the manual laser process can be easily executed.

When the manual drive mode DM2 is selected by the mode selection switch 48 (determined NO in step S13, S14, or S17), the processor 40 of the controller 18 may execute a cooperation program PG′ that causes the robot 12 to implement cooperation for assisting the manual laser process by the operator.

The cooperation program PG′ may be configured to cause the robot 12 to implement cooperation by holding and moving (e.g., rotating) the workpiece or loading the workpiece onto a jig while the operator is manually executing the laser process, for example. In this case, a robot hand capable of holding the workpiece may be attached to the wrist 28 of the robot 12 in addition to (or instead of) the laser emitting device 14. With this configuration, the operator can effectively execute the manual laser process in cooperation with the robot 12.

Upon determining YES in step S31 or S33 in FIG. 9, the processor 40 may execute step S15 described above to determine whether or not the laser emitting device 14 is detached from the robot 12. Upon determining that the laser emitting device 14 is attached to the robot 12 (that is, NO), the processor 40 may stop at least one of the laser beam emitting operation LO as the manual drive mode DM2 and the above-described cooperation with the robot 12, and may generate the alarm signal AL as in step S22 described above.

In this case, the processor 40 may receive in advance from the operator through the input device 50, setting data indicating whether or not to stop the laser beam emitting operation LO as the manual drive mode DM2, whether or not to stop the cooperation, and whether or not to generate the alarm signal. With this configuration, the operator can design the operations of the robot 12 and the laser oscillator 16 in the manual drive mode DM2 as desired.

In the above-described embodiment, a case is described where the attachment detection sensor 54 is configured by a contact sensor or a non-contact sensor. However, the present invention is not limited thereto, and the attachment detection sensor 54 may be configured by, for example, the torque sensor, the six-axis force sensor, or the current sensor described above.

The controller 18 can detect whether or not the laser emitting device 14 is attached to the robot 12 from the detection data Dt of the torque sensor, the detection data Df of the six-axis force sensor, or the detection data Di of the current sensor. In this case, the torque sensor, the six-axis force sensor, or the current sensor may have both the function of the force sensor 56 that detects the external force F and the function of the attachment detection sensor 54 that detects attachment of the laser emitting device 14 to the robot 12. That is, in this case, the torque sensor, the six-axis force sensor, or the current sensor functions as the force sensor 56 and the attachment detection sensor 54.

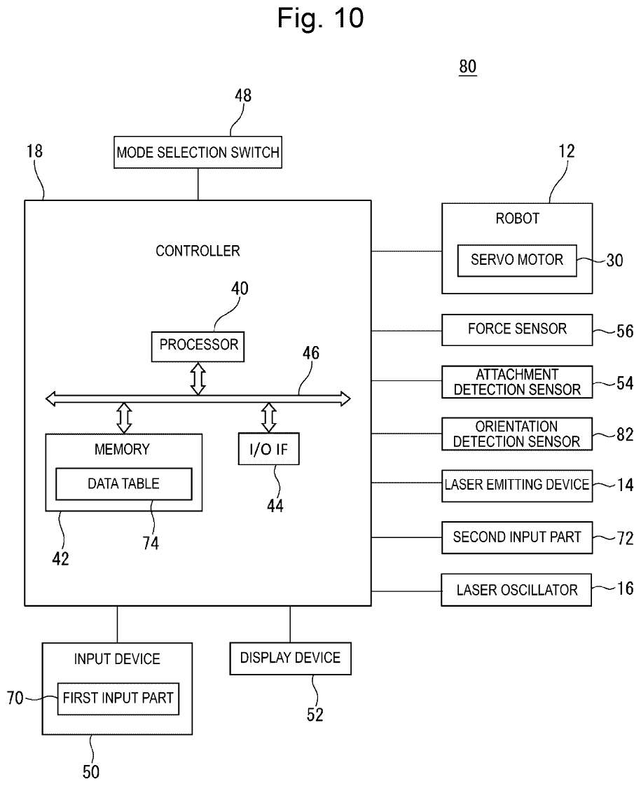

Next, a laser process system 80 according to another embodiment is described with reference to FIG. 1 and FIG. 10. The laser process system 80 is different from the laser process system 10 described above in that an orientation detection sensor 82 is further provided. The orientation detection sensor 82 detects the orientation OR of the laser emitting device 14. The orientation OR can be represented by the coordinates (W, P, R) indicating the directions of axes of a tool coordinate system C2 in the robot coordinate system C1, for example.

As an example, the orientation detection sensor 82 includes an encoder (or a hall element) that is incorporated in each of the servomotors 30 of the robot 12, and detects the rotation of the servomotor 30 (e.g., a rotation angle or a rotation position). The processor 40 of the controller 18 can obtain the orientation OR of the laser emitting device 14 from detection data Dc of each encoder.

As another example, the orientation detection sensor 82 may include a gyro sensor provided at the laser emitting device 14 (or the wrist flange 28b). The processor 40 can obtain the orientation OR of the laser emitting device 14 from detection data Dg of the gyro sensor. The orientation detection sensor 82 is connected to the I/O interface 44 of the controller 18, and the processor 40 acquires the detection data Dc or Dg of the orientation detection sensor 82 via the I/O interface 44, and obtains the coordinates (W, P, R) of the orientation OR in the robot coordinate system C1 through calculation based on the detection data Dc or Dg.

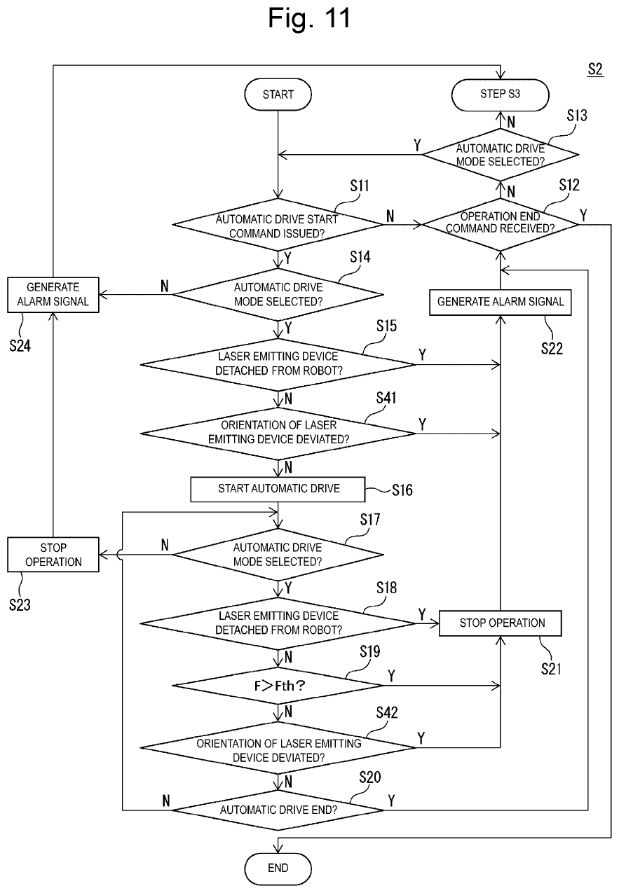

Next, a laser process method executed by the laser process system 80 will be described with reference to FIG. 7 and FIG. 11. The processor 40 of the controller 18 in the laser process system 80 executes an operation flow illustrated in FIG. 7. The operation flow of the laser process system 80 is different from that of the laser process system 10 described above in step S2. FIG. 11 illustrates step S2 executed by the laser process system 80. Note that in the flow illustrated in FIG. 11, processes similar to those of the flow illustrated in FIG. 8 are assigned identical step numbers, and overlapping descriptions thereof will be omitted.

In step S2 illustrated in FIG. 11, upon determining NO in step S15, the processor 40 determines in step S41, whether or not the orientation OR detected by the orientation detection sensor 82 is deviated from a target orientation OR_{T} defined in the process program PG. Specifically, the processor 40 acquires the coordinates Q (W, P, R) indicating the orientation OR of the laser emitting device 14 most recently detected by the orientation detection sensor 82, and expresses the coordinates Q (W, P, R) using a 3×3 matrix M.

In this matrix M, a vector V1 represented by three parameters in a first column is a unit vector representing the rotation component around the x-axis of the tool coordinate system C2, a vector V2 represented by three parameters in a second column is a unit vector representing the rotation component around the y-axis of the tool coordinate system C2, and a vector V3 represented by three parameters in a third column is a unit vector representing the rotation component around the z-axis of the tool coordinate system C2.

On the other hand, the processor 40 acquires coordinates Q_{T} (W_{T}, P_{T}, R_{T}) of the target orientation OR_{T} at the current time point from the process program PG, and expresses the coordinates Q_{T} (W_{T}, P_{T}, R_{T}) using a 3×3 matrix MT. Then, the processor 40 obtains an inner product IP1 of the vector V1 in the first column of the matrix M and a vector V1_{T} in the first column of the matrix MT. This inner product IP1 represents an angle φ1 (specifically, cos φ1) between the vector V1 and the vector V1_{T}, that is, the amount of deviation of the orientation OR from the target orientation OR_{T} in a direction around the x-axis of the tool coordinate system C2.

The processor 40 also calculates an inner product IP3 between a vector V3 in the third column of the matrix M (or a vector V2 in the second column) and a vector V3_{T} in the third column of the matrix MT (or a vector V2_{T} in the second column). This inner product IP3 represents an angle φ3 (specifically, cos φ3) between the vector V3 and the vector V3_{T}, that is, the amount of deviation of the orientation OR from the target orientation OR_{T} in a direction around the z-axis of the tool coordinate system C2.

The processor 40 determines whether or not the obtained inner product IP1 is equal to or less than a predetermined threshold IP1ₜₕ (IP1≤IP1ₜₕ), and also determines whether or not the obtained inner product IP3 is equal to or less than a predetermined threshold IP3ₜₕ (IP3≤IP3ₜₕ). When IP1≤IP1ₜₕ or IP3≤IP3ₜₕ holds, the processor 40 determines that the orientation OR of the laser emitting device 14 at the current time point is deviated from the target orientation OR_{T} (i.e., determines YES).

On the other hand, when IP1>IP1ₜₕ and IP3>IP3ₜₕ hold, the processor 40 determines that the orientation OR of the laser emitting device 14 at the current time point substantially matches the target orientation OR_{T} (i.e., determines NO). The processor 40 proceeds to step S22 upon determining YES in step S41, and proceeds to step S16 upon determining NO.

Upon determining NO in step S19, the processor 40 determines in step S42, whether or not the orientation OR most recently detected by the orientation detection sensor 82 is deviated from the target orientation OR_{T}, as in the above-described step S41. The processor 40 proceeds to step S21 upon determining YES, and proceeds to step S20 upon determining NO.

As described above, in the present embodiment, the controller 18 (processor 40) stops at least one of the laser beam emitting operation LO and the movement operation MO (step S21), upon determining that the orientation OR detected by the orientation detection sensor 82 is deviated from the target orientation OR_{T} while executing the laser beam emitting operation LO and the movement operation MO as the automatic drive mode DM1 (that is, upon determining YES in step S42). With this configuration, for example, the safety of the operator can be reliably ensured, when the orientation OR largely changes due to interference between the robot 12 or the laser emitting device 14 and the environmental object or the like.

In the present embodiment, upon determining that the orientation OR detected by the orientation detection sensor 82 is deviated from the target orientation OR_{T} at the time of input of the automatic drive start command CM6 (determined YES in step S41), the controller 18 does not start at least one (specifically, both) of the laser beam emitting operation LO or the movement operation MO. With this configuration, the safety of the operator can be reliably ensured when the automatic drive starts. The processor 40 may start the laser beam emitting operation LO or the movement operation MO as the automatic drive mode DM1 also upon determining YES in step S41.

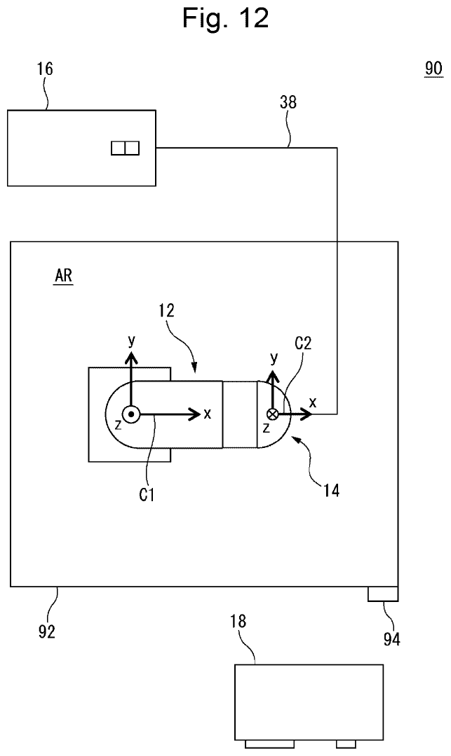

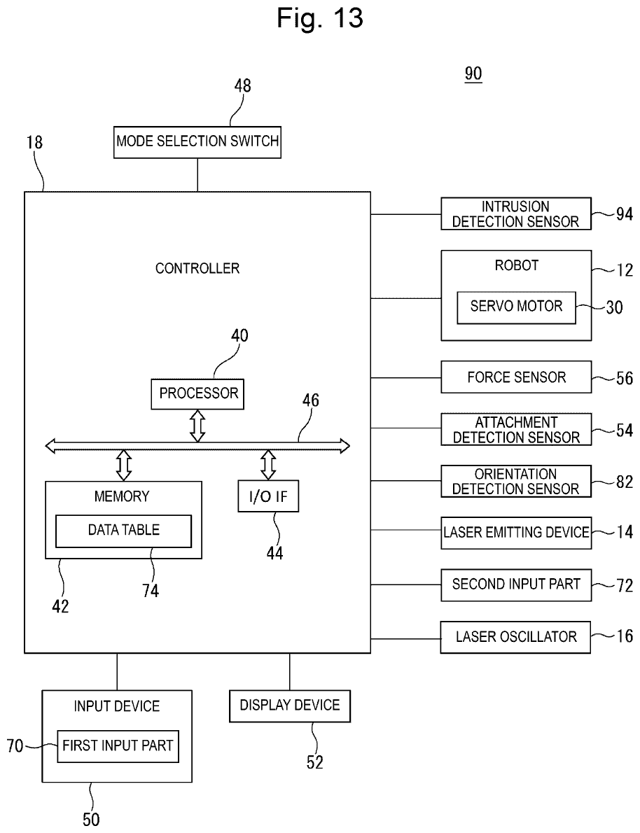

Next, a yet another laser process system 90 will be described with reference to FIG. 12 and FIG. 13. The laser process system 90 is different from the laser process system 80 described above in that a safety barrier 92 and an entry detection sensor 94 are further provided. The safety barrier 92 is disposed so as to surround the robot 12, and defines a work area AR for the robot 12 therein. The work area AR includes a movable area of the robot 12.

As an example, the safety barrier 92 includes a physical fence having an entrance, and a door with which the entrance of the physical fence is opened and closed automatically or manually. As another example, the safety barrier 92 may include a plurality of electromagnetic wave emitting devices, and the work area AR may be defined by electromagnetic waves (e.g., infrared rays) emitted by the plurality of electromagnetic wave emitting devices.

The entry detection sensor 94 detects the entry of the operator into the work area AR. As an example, when the safety barrier 92 includes the physical fence and the door, the entry detection sensor 94 includes a door sensor that detects the opening and closing of the door. The door sensor can detect the entry of the operator into the work area AR by detecting the opening and closing of the door.

As another example, when the safety barrier 92 includes the electromagnetic wave emitting devices, the entry detection sensor 94 includes an electromagnetic wave sensor that receives the electromagnetic waves emitted by the electromagnetic wave emitting devices. When an object (e.g., the body of the operator) crosses the electromagnetic waves, the electromagnetic wave sensor detects the blocking of the electromagnetic waves emitted by the electromagnetic wave emitting devices, and thus can detect the entry of the operator into the work area AR. The entry detection sensor 94 is connected to the I/O interface 44 of the controller 18 and transmits an entry detection signal Se indicating the entry of the operator into the work area AR to the controller 18.

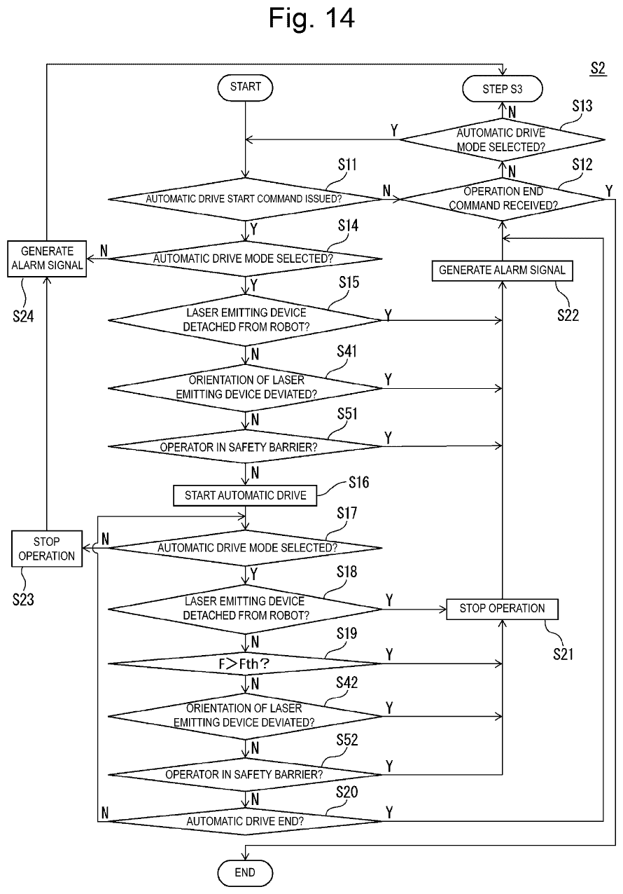

Next, a laser process method executed by the laser process system 90 will be described with reference to FIG. 7 and FIG. 14. The processor 40 of the controller 18 in the laser process system 90 executes the operation flow illustrated in FIG. 7. The operation flow of the laser process system 90 is different from that of the laser process system 80 described above in step S2. FIG. 14 illustrates step S2 executed by the laser process system 90. Note that in the flow illustrated in FIG. 14, processes similar to those of the flow illustrated in FIG. 11 are assigned identical step numbers, and overlapping descriptions thereof will be omitted.

In step S2 illustrated in FIG. 14, upon determining NO in step S41, the processor 40 determines in step S51 whether or not the operator has entered the work area AR. Specifically, the processor 40 determines whether or not the operator has entered the work area AR based on the entry detection signal Se received from the entry detection sensor 94. The processor 40 determines YES when the entry of the operator into the work area AR is detected by the entry detection sensor 94 and proceeds to step S22. On the other hand, the processor 40 proceeds to step S16 upon determining NO.

Upon determining NO in step S42, the processor 40 determines in step S52, whether or not the operator has entered the work area AR, as in step S51 described above. The processor 40 proceeds to step S21 upon determining YES, and proceeds to step S20 upon determining NO.

As described above, in the present embodiment, the controller 18 (processor 40) stops at least one of the laser beam emitting operation LO and the movement operation MO (step S21), upon determining that the entry of the operator into the work area AR is detected by the entry detection sensor 94 while executing the laser beam emitting operation LO and the movement operation MO as the automatic drive mode DM1 (upon determining YES in step S52). With this configuration, the safety of the operator can be reliably ensured while the automatic drive is being executed.

In the present embodiment, upon determining that the entry detection sensor 94 has detected the entry of the operator into the work area AR at the time of input of the automatic drive start command CM6 (determined YES in step S51), the controller 18 does not start at least one (specifically, both) of the laser beam emitting operation LO or the movement operation MO. With this configuration, the safety of the operator can be reliably ensured when the automatic drive starts. The processor 40 may start the laser beam emitting operation LO or the movement operation MO as the automatic drive mode DM1 also upon determining YES in step S51.

The mode selection switch 48 described above may be provided at any component other than the controller 18. For example, the mode selection switch 48 may be configured as a portable switch that is provided separately from the controller 18 and can be carried by the operator. Alternatively, the mode selection switch 48 may be provided at a teaching device (such as a teaching pendant or a tablet-type terminal device) that is communicably connected to the controller 18 and teaches operations to the robot 12 and the laser oscillator 16.

In the above-described embodiment, a case is described where the mode selection switch 48 is a physical switch provided in the controller 18. Alternatively, the mode selection switch 48 may be provided at the controller 18 as a software switch (or a virtual switch).

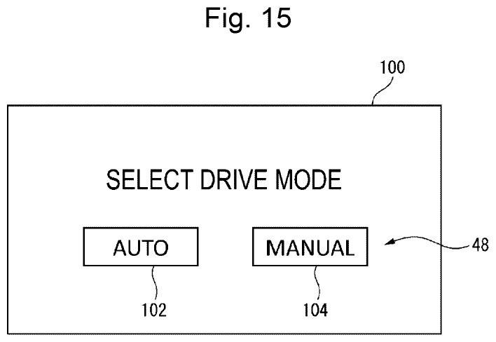

For example, the processor 40 of the controller 18 generates a mode selection switch image 100 for selecting the drive mode DM and displays the mode selection switch image 100 at the display device 52. FIG. 15 illustrates an example of the mode selection switch image 100. The mode selection switch image 100 is a graphical user interface (GUI) for enabling the operator to select the drive mode DM, and includes an automatic drive button image 102 and a manual drive button image 104.

The automatic drive button image 102 represented as “AUTO” corresponds to the automatic drive mode DM1, and the manual drive button image 104 represented as “MANUAL” corresponds to the manual drive mode DM2. The operator can select the automatic drive mode DM1 or the manual drive mode DM2 by operating the input device 50 to click the automatic drive button image 102 or the manual drive button image 104 on the image while visually recognizing the mode selection switch image 100 displayed at the display device 52.

When the processor 40 receives an input of selecting the automatic drive button image 102 (that is, the automatic drive mode transition command CM4) from the operator through the input device 50, the processor 40 makes the drive mode DM transition to the automatic drive mode DM1 (step S2 described above). On the other hand, when the processor 40 receives an input of selecting the manual drive button image 104 (that is, the manual drive mode transition command CM5) from the operator through the input device 50, the processor 40 makes the drive mode DM transition to the manual drive mode DM2 (step S3 described above).

As described above, the automatic drive button image 102 and the manual drive button image 104 constitute the mode selection switch 48 as software, and the operator can switch the drive mode DM between the automatic drive mode DM1 and the manual drive mode DM2 by operating the mode selection switch 48 on the image. The mode selection switch 48 as software may be mounted not only at the controller 18 but also at the above-described teaching device or any other communication device (PC or tablet terminal) communicably connected to the controller 18.

In the embodiment described above, the automatic drive mode DM1 and the manual drive mode DM2 are described as examples of the drive mode DM. However, the drive mode DM is not limited thereto, and may include any other drive mode DM such as a teaching drive mode DM3 for teaching an operation to the robot 12 and the laser oscillator 16, for example.

For example, in the teaching drive mode DM3, by operating the teaching device, the operator can cause the robot 12 to perform a jogging operation and cause the laser oscillator 16 to generate a guide laser beam LBg via the controller 18. The guide laser beam LBg is a laser beam having a laser power lower than that of the laser beam LB used in an actual laser process and having a wavelength of visible light visible to the operator.

In the teaching drive mode DM3, the operator operates the teaching device to teach a teaching point TP at which the laser emitting device 14 is positioned by the robot 12 for the laser process, and causes the laser oscillator 16 to generate the guide laser beam LBg and emit the guide laser beam LBg from the laser emitting device 14, thereby teaching a timing TM at which the laser beam LB is emitted for the laser process, a radiation position RP of the laser beam LB, a focal position FP of the laser beam LB, and the like. Based on the taught teaching point TP, timing TM, radiation position RP, and focal position FP, the processor of the teaching device generates the process program PG in which these parameters are defined.

In the teaching drive mode DM3, the operator may operate the teaching device to execute a semi-automatic drive for recognizing the taught operation by experimentally executing an incomplete process program PG′ generated in the middle of the teaching (that is, whether or not the process program PG′ is appropriate). In the semi-automatic drive, the controller 18 may cause the laser oscillator 16 to generate the guide laser beam LBg and cause the robot 12 to operate at a speed lower than that in the actual laser process in accordance with the process program PG′.

The mode selection switch 48 may be configured to switch the drive mode DM among, for example, the automatic drive mode DM1, the manual drive mode DM2, and the teaching drive mode DM3 as described above. When the teaching drive mode DM3 is selected by the mode selection switch 48, the mode selection switch 48 supplies a teaching drive mode transition command CM8 to the controller 18. When the teaching drive mode transition command CM8 is received, the controller 18 makes the drive mode DM transition to the teaching drive mode DM3, and enters a state in which commands for the above-described jogging operation, generation of the guide laser beam LBg, and semi-automatic drive can be received from the teaching device.

In the above-described embodiment, a case is described where the laser emitting device 14 is provided with the second input part 72. However, the present disclosure is not limited thereto, and the second input part 72 may be configured as a portable button device that is provided separately from the laser emitting device 14 and can be carried by the operator.

At least one of the force sensor 56 and the orientation detection sensor 82 can be omitted in the above-described embodiment. For example, the force sensor 56 may be omitted from the laser process system 10 illustrated in FIG. 2. In this case, step S19 is omitted from the flow of step S2 illustrated in FIG. 8. Thus, when the determination is NO in step S18, the processing proceeds to step S20.

The flows illustrated in FIG. 7 to FIG. 9, FIG. 11, and FIG. 14 are examples of the laser process method executed by the laser process system 10, 80, or 90, and the order of the processes to be executed may be changed or any other process may be added. For example, in the flow illustrated in FIG. 14, step S51 may be executed after determining YES in step S14, and then steps S15 and S41 may be executed. Alternatively, step S17 may be executed after determining YES in step S52, and then steps S18, S19, and S42 may be executed.

Further, in the flow illustrated in FIG. 9, the processor 40 may execute step S11 described above after determining YES in step S31 or S33, start step S2 when determining YES (that is, when the automatic drive mode DM1 is selected by the mode selection switch 48), and proceed to step S32 or S33 when determining NO. As described above, various changes can be made to the flows illustrated in FIGS. 7 to 9, 11, and 14.

The first input part 70 may be omitted from the laser process system 10, 80, or 90, and the function of the first input part 70 may be provided at an external apparatus of the laser process system 10, 80, or 90. For example, a host controller that issues a command to the controller 18 may be connected to the controller 18 via a communication network (such as a LAN or the Internet). An input device of the host controller may function as the first input part 70. In this case, the processor 40 of the controller 18 acquires the automatic drive start command CM6 input through the input device of the host controller via the communication network.

In addition, only the automatic drive mode DM1 may be set as the drive mode DM, and the mode selection switch 48 may be configured to select the automatic drive mode DM1 and an OFF mode in which no drive mode DM is selected. In this case, the second input part 72 can be omitted from the laser process system 10, 80, or 90. Then, step S3 is omitted from the flow in FIG. 7. In this case as well, the safety of the operator for the automatic drive can be ensured.

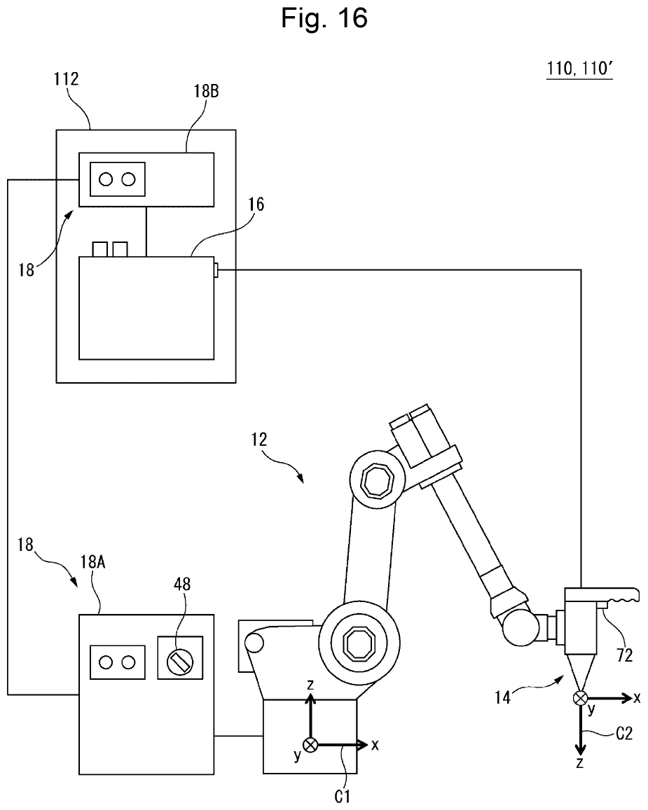

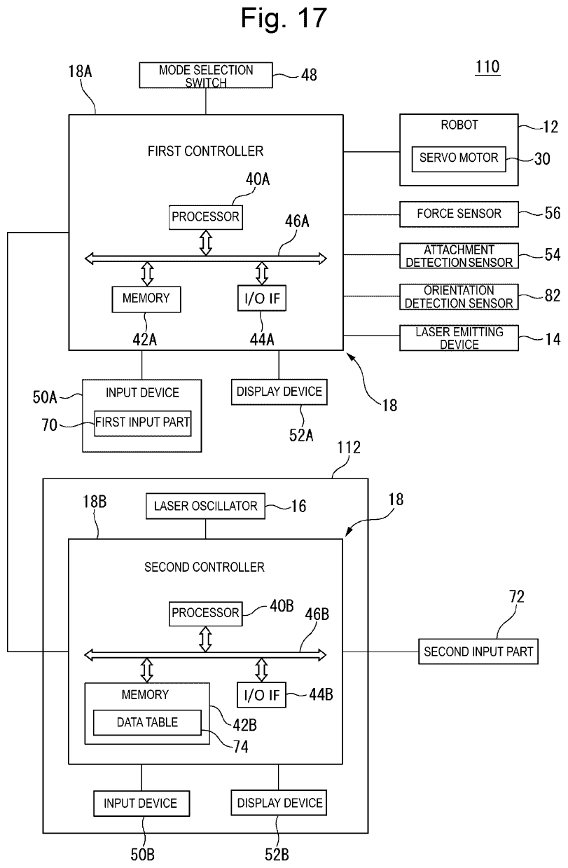

In addition, in the embodiments described above, a case is described where the controller 18 controls the robot 12 and the laser oscillator 16. Alternatively, the controller 18 may include a first controller 18A that controls the robot 12 and a second controller 18B that controls the laser oscillator 16. Such an embodiment is illustrated in FIG. 16 and FIG. 17.

A laser process system 110 illustrated in FIG. 16 and FIG. 17 is different from the above-described laser process system 80 in the controller 18. Specifically, the controller 18 includes the first controller 18A that controls the movement operation MO of the robot 12, and the second controller 18B that controls the laser beam emitting operation LO of the laser oscillator 16.

The first controller 18A is a computer that includes a processor 40A, a memory 42A, an I/O interface 44A, and a bus 46A. The robot 12 (servomotor 30), the laser emitting device 14 (lens drive part), an input device 50A functioning as the first input part 70, a display device 52A, the attachment detection sensor 54, the force sensor 56, and the orientation detection sensor 82 are communicably connected to the I/O interface 44A of the first controller 18A. The mode selection switch 48 described above is provided in the first controller 18A.

The second controller 18B is a computer that includes a processor 40B, a memory 42B, an I/O interface 44B, and a bus 46B. An input device 50B, a display device 52B, the laser oscillator 16, the second input part 72, and the I/O interface 44A of the first controller 18A are communicably connected to the I/O interface 44B of the second controller 18B.

The memory 42B stores the above-mentioned data table 74. Note that the laser oscillator 16, the second controller 18B, the input device 50B, and the display device 52B may be integrated as a unit incorporated into a common housing to form a single laser oscillation device 112 (FIG. 16 and FIG. 17).

In the present embodiment, the first controller 18A and the second controller 18B execute the flows illustrated in FIG. 7, FIG. 9, and FIG. 11 while communicating with each other. Here, in step S3 (manual drive mode DM2) illustrated in FIG. 9, the processor 40B of the second controller 18B may execute steps S31 to S35, while the processor 40A of the first controller 18A executes step S36.

Here, in the present embodiment, the processor 40B of the second controller 18B presets the output condition C_{O} in the manual drive mode DM2 based on the data table 74, as in the above-described embodiment. In step S32, in response to the manual emission command CM3 from the second input part 72, the processor 40B generates a command CM1_₁ for the laser oscillator 16 in accordance with the preset output condition C_{O}, and executes a laser beam emission operation LO so as to generate the laser beam LB having the laser power, the duty ratio, and the pulse oscillation frequency defined in the output condition C_{O}.

On the other hand, in step S2 (automatic drive mode DM1) illustrated in FIG. 11, the processor 40A of the first controller 18A and the processor 40B of the second controller 18B may cooperatively execute the automatic drive in step S16, while the processor 40A of the first controller 18A executes steps S11 to S15, S41, S17 to S19, S42, and S20 to S24.

As an example of step S16, the processor 40A of the first controller 18A executes the process program PG (e.g., the first process program PG1), and transmits a command CM1_₂ of an output condition C_{O}′ (specifically, laser power, duty ratio, and pulse oscillation frequency) for the automatic drive defined in the process program PG, to the second controller 18B.

In accordance with the command CM1_₂, the processor 40B of the second controller 18B provides the laser oscillator 16 with a command CM1_₃ for generating the laser beam LB having the laser power, the duty ratio, and the pulse oscillation frequency defined in an output condition C_{O}′, and causes the laser oscillator 16 to execute the laser beam emission operation LO in accordance with the command CM1_₃. At the same time, the processor 40A of the first controller 18A issues the command CM2 to the robot 12 and causes the robot 12 to execute the movement operation MO, as the automatic operation.

As another example of step S16, the memory 42B of the second controller 18B may store in advance a data table 74′ in which the output condition C_{O}′ for the automatic drive is stored in association with the process condition C_{P} for the workpiece. In this case, in this step S16, the processor 40A of the first controller 18A issues a command CM1_₄ designating an output condition C_{O}′ in the data table 74′ (e.g., the identification number of the output condition C_{O}′ in the data table 74′) to the second controller 18B. The command CM1_₄ may be defined in the process program PG (e.g., the first process program PG1). Note that the above-described second input part 72 may be configured to further receive an input of the command CM1_₄ designating the output condition C_{O}′ in addition to the manual emission command CM3.

The processor 40B of the second controller 18B acquires, from the data table 74′, the output condition C_{O}′ designated by the command CM1_₄ from the first controller 18A, provides the laser oscillator 16 with a command CM1_₅ for generating the laser beam LB with the laser power, the duty ratio, and the pulse oscillation frequency defined by the output condition C_{O}′, and causes the laser oscillator 16 to execute the laser beam emission operation LO in accordance with the command CM1_₅. At the same time, the processor 40A of the first controller 18A issues the command CM2 to the robot 12 and causes the robot 12 to execute the movement operation MO, as the automatic operation.

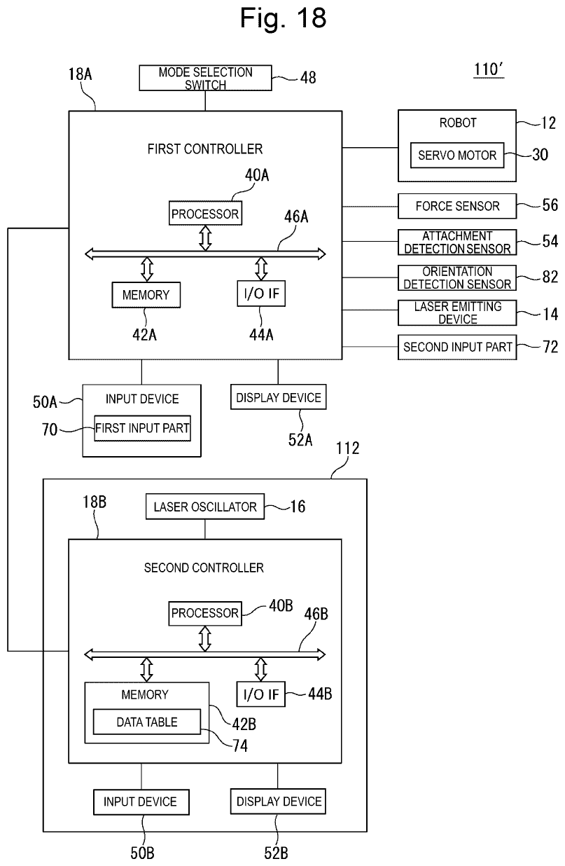

In the above-described laser process system 110, a case is described where the second input part 72 is connected to the second controller 18B and issues the manual emission command CM3 to the second controller 18B. However, the present invention is not limited thereto, and the second input part 72 may be connected to the first controller 18A. Such an embodiment is illustrated in FIG. 16 and FIG. 18.

In a laser process system 110′ illustrated in FIG. 16 and FIG. 18, the second input part 72 is connected to the I/O interface 44A of the first controller 18A and issues the manual emission command CM3 to the first controller 18A. The data table 74 described above is stored in the memory 42B of the second controller 18B.

Also in the laser process system 110′, the first controller 18A and the second controller 18B execute the flows illustrated in FIGS. 7, 9, and 11 while communicating with each other. Specifically, as in the laser process system 110 described above, the processor 40B of the second controller 18B presets the output condition C_{O} in the manual drive mode DM2 based on the data table 74.

In step S32 in FIG. 9, in response to the manual emission command CM3 from the second input part 72, the processor 40A of the first controller 18A issues a command CM1_₆ designating the output condition C_{O} in the data table 74 (e.g., the identification number of the output condition C_{O} in the data table 74′) to the second controller 18B. The command CM1_₆ may be defined in the process program PG (e.g., the first process program PG1). Note that the second input part 72 may be configured to further receive an input of the command CM1_₆ designating the output condition C_{O} in addition to the manual emission command CM3.

The processor 40B of the second controller 18B acquires, from the data table 74, the output condition C_{O} designated by the command CM1_₆ from the first controller 18A, provides the laser oscillator 16 with a command CM1_₇ for generating the laser beam LB with the laser power, duty ratio, and pulse oscillation frequency defined by the output condition C_{O}, and causes the laser oscillator 16 to execute the laser beam emission operation LO in accordance with the command CM1_₇. The processor 40A of the first controller 18A and the processor 40B of the second controller 18B execute step S16 (automatic drive) in FIG. 11 in cooperation with each other, as in the above-described laser process system 110.

In the laser process system 110 or 110′, the data table 74 (and the data table 74′) may be stored in the memory 42A of the first controller 18A. In this case, in step S32 or S16, the processor 40A of the first controller 18A may issue the command CM1 (such as the laser power command) for generating the laser beam LB under the output condition C_{O} or C_{O}′ defined in the data table 74 or 74′, to the laser oscillator 16 via the second controller 18B. The laser process system 110 or 110′ may be provided with the safety barrier 92 and the entry detection sensor 94 described above, and the first controller 18A and the second controller 18B may execute the flows in FIG. 7, FIG. 9, and FIG. 14 in cooperation with each other.

In the embodiments described above, a case in which the laser emitting device 14 is a laser process head is described. However, the present disclosure is not limited thereto, and the laser emitting device 14 may be any type of device such as a laser scanner (or galvano scanner) for example. The laser scanner includes a plurality of mirrors that each reflect the laser beam LB supplied from the laser oscillator 16, a plurality of mirror drive parts that individually drive the plurality of mirrors, an optical lens that collects the laser beams reflected by the mirrors, and the like. The laser scanner can move the irradiation point of the laser beam with which the workpiece is irradiated, at high speed in the x-y plane of the robot coordinate system C1 by making the mirror drive parts change the orientations of the plurality of mirrors.

The robot 12 is not limited to a vertical articulated type robot and may be, for example, a horizontal articulated type robot or a parallel link type robot. The robot 12 may be configured to include first and second ball screw mechanisms that move the workpiece in the x-y plane of the robot coordinate system C1 and a third ball screw mechanism that moves the laser emitting device 14 in the z-axis direction of the robot coordinate system C1. Although the present disclosure has been described through embodiments above, the embodiments described above do not limit the scope of the invention claimed in the claims.

### REFERENCE SIGNS LIST

10, 80, 90, 110, 110′ Laser process system
12 Robot
14 Laser emitting device
16 Laser oscillator
18, 18A, 18B Controller
36 Gripping part
40 Processor
48 Mode selection switch
54 Attachment detection sensor
56 Force sensor
70 First input part
72 Second input part
82 Orientation detection sensor

1. A laser process system configured to perform a laser process on a workpiece, the laser process system comprising:
a laser emitting device configured to emit a laser beam generated by a laser oscillator;
a robot to which the laser emitting device is detachably attached, and which is configured to move the laser emitting device relative to the workpiece;
an attachment detection sensor configured to detect attachment of the laser emitting device to the robot;
a controller configured to control a laser beam emitting operation to operate the laser oscillator so as to emit the laser beam from the laser emitting device, and a movement operation to operate the robot so as to move the laser emitting device relative to the workpiece; and
a mode selection switch for selecting a drive mode of the laser process,
wherein the controller executes the laser beam emitting operation and the movement operation as an automatic drive mode in which the laser beam emitting operation and the movement operation are automatically executed in accordance with a process program, when the automatic drive mode is selected as the drive mode by the mode selection switch and the attachment detection sensor detects the attachment of the laser emitting device to the robot.

2. The laser process system according to claim 1, further comprising a first input part configured to receive an input of an automatic drive start command for causing the controller to start the automatic drive mode,
wherein the controller does not start at least one of the laser beam emitting operation and the movement operation as the automatic drive mode, in a case where the automatic drive mode is not selected by the mode selection switch or the attachment detection sensor detects detachment of the laser emitting device from the robot, when the first input part receives the input.

3. The laser process system according to claim 2, wherein the controller generates an alarm signal in a case where the automatic drive mode is not selected by the mode selection switch or the attachment detection sensor detects the detachment when the first input part receives the input.

4. The laser process system according to claim 1, wherein the controller stops at least one of the laser beam emitting operation and the movement operation when the mode selection switch is operated to deselect the automatic drive mode or the attachment detection sensor detects detachment of the laser emitting device from the robot, while executing the laser beam emitting operation and the movement operation as the automatic drive mode.

5. The laser process system according to claim 1, further comprising a force sensor configured to detect external force applied to the robot or the laser emitting device,
wherein the controller stops at least one of the laser beam emitting operation and the movement operation when the external force detected by the force sensor exceeds a predetermined threshold while executing the laser beam emitting operation and the movement operation as the automatic drive mode.

6. The laser process system according to claim 1, further comprising an orientation detection sensor configured to detect an orientation of the laser emitting device,
wherein the controller stops at least one of the laser beam emitting operation and the movement operation when the orientation detected by the orientation detection sensor is deviated from a target orientation defined in the process program while executing the laser beam emitting operation and the movement operation as the automatic drive mode.

7. The laser process system according to claim 1, further comprising a second input part configured to receive an input of a manual emission command for causing the controller to execute the laser beam emitting operation,
wherein the mode selection switch is configured to switch the drive mode between the automatic drive mode and a manual drive mode in which the controller executes the laser beam emitting operation in response to the manual emission command, and
wherein the controller executes the laser beam emitting operation as the manual drive mode in response to the manual emission command received through the second input part when the manual drive mode is selected by the mode selection switch.

8. The laser process system according to claim 7, further comprising a data table in which a process condition for the laser process on the workpiece in the manual drive mode, and an output condition for the laser beam to be emitted in the laser beam emitting operation in the manual drive mode are stored in association with each other,
wherein the controller sets the output condition in the manual drive mode based on the data table.

9. The laser process system according to claim 7, wherein the laser emitting device includes a gripping part configured to be gripped with one hand, and
wherein the second input part is provided at the laser emitting device adjacent to the gripping part such that the one hand gripping the gripping part is able to perform an input-operation.

10. The laser process system according to claim 1, wherein the attachment detection sensor includes:
a contact sensor configured to detect the attachment by conducting when the laser emitting device is attached to the robot and non-conducting when the laser emitting device is detached from the robot; or
a non-contact sensor including a transmitter configured to transmit an electromagnetic wave from one of the laser emitting device and the robot to the other of the laser emitting device and the robot, and a receiver configured to receive the electromagnetic wave from the transmitter, the non-contact sensor being configured to detect the attachment in response to the electromagnetic wave received by the receiver.

11. A method of performing a laser process using the laser process system according to claim 1, the method comprising:
determining, by a processor, whether or not the automatic drive mode is selected by the mode selection switch;
determining, by the processor, whether or not the attachment of the laser emitting device to the robot is detected by the attachment detection sensor, and
executing, by the processor, the laser beam emitting operation and the movement operation as the automatic drive mode, when the automatic drive mode is selected by the mode selection switch and the attachment of the laser emitting device to the robot is detected.
